(19) United States
(12) Patent Application Publication
(10) Pub. No.: US 2006/0062306 A1
(43) Pub. Date: Mar. 23, 2006

(54) Method for motion estimation based on hybrid block matching and apparatus for converting frame rate using the method

(75) Inventors: Tae-hyeun Ha, Suwon-si (KR); Jae-seok Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/171,344

(22) Filed: Jul. 1, 2005

(30) Foreign Application Priority Data
Sep. 18, 2004 (KR) 10-2004-0074823

(51) Int. Cl. H04N 11/02; H04N 7/12; H04N 11/04; H04B 1/66

(52) U.S. Cl. 375/240.16; 375/240.24; 375/240.12

(57) ABSTRACT

Provided are a method of motion estimation based on hybrid block matching using overlapping blocks in a video encoder, and an apparatus for converting a frame rate using the method. The method includes dividing a current frame into blocks and performing a full search algorithm on blocks sampled from the divided blocks, allocating motion vectors (fMV) obtained through linear interpolation to non-sampled blocks in the current frame based on a motion vector (iMV) obtained through the full search, and performing a fast search algorithm using the motion vector obtained through linear interpolation as a search starting point.

### BACKGROUND OF THE INVENTION

This application claims priority from Korean Patent Application No. 10-2004-0074823, filed on Sep. 18, 2004, in the Korean Intellectual Property Office, the disclosure of which is incorporated herein in its entirety by reference.

1. Field of the Invention

Apparatuses and methods consistent with the present invention relate to frame rate conversion, and more particularly, to motion estimation based on hybrid block matching using overlapping blocks.

2. Description of the Related Art

Typically, personal computers (PC) or high-definition televisions (HDTV) perform frame rate conversion to be compatible with programs that follow various broadcasting standards such as the Phase Alternation Line (PAL) or the National Television System Committee (NTSC). Frame rate conversion is the act of changing the number of frames per second. In particular, it is necessary to interpolate a new frame when a frame rate increases. With recent advances in broadcasting technologies, frame rate conversion is performed after video data is compressed according to video compression standards such as Moving Picture Experts Group (MPEG) and H.263.

In the field of video processing, video signals usually have redundancies due to their high autocorrelation. Data compression efficiency can be improved by removing redundancies during data compression. Here, in order to efficiently compress a video frame that changes temporally, it is necessary to remove redundancies in the time-axis direction. In other words, by replacing a frame showing no movement or slight movement with a previous frame, the amount of data to be transmitted can be greatly reduced. Motion estimation (ME) is the act of searching for a block in a previous frame that is most similar to a block in a current frame. A motion vector (MV) indicates how much a block has moved.

Existing MV algorithms include a full-search block matching algorithm (FSBMA) and a fast search algorithm (FSA).

The FSBMA involves dividing consecutively input video into pixel blocks of a predetermined size and determining a location of a block in a previous or following frame that is most similar to each of the divided blocks as an MV. In other words, a relative distance between a block in an input frame and a block in a reference frame that is most similar to the block in the input frame is referred to as the MV. In block-based motion estimation, a mean absolute difference (MAD), a mean square error (MSE), or a sum of absolute difference (SAD) is usually used to determine a similarity between adjacent blocks. Here, since the MAD does not require multiplication, it requires only a small amount of calculation and can be easily implemented in hardware. Therefore, the FSBMA using a MAD estimates a block having the minimum MAD for a block in a reference frame among blocks in a frame that is adjacent to the reference frame and obtains a motion vector between the block in the reference frame and the estimated block.

However, although the FSBMA is a simple and idealistically accurate MV algorithm, it requires a huge amount of calculation and therefore is not appropriate for real-time encoding.

Meanwhile, compared to the FSBMA, the FSA greatly reduces the amount of calculation at the cost of accuracy, and is appropriate for real-time video encoders (for example, video telephones, IMT-2000 terminals, video conference systems, etc.), in which video quality is relatively less important. Examples of the FSA include a hierarchical search block matching algorithm (HSBMA), a one-pixel greedy search (OPGS), a three-step search (TSS) algorithm, a diamond search algorithm, a four-step search (FSS) algorithm, and a gradient search algorithm.

Here, the HSBMA has high accuracy and is relatively less affected by the amount of motion, but involves a substantial amount of calculation and requires a memory for storing low-resolution frames. Also, the HSBMA requires a substantial amount of calculation both for a long-distance motion vector and a short-distance motion vector, without distinction.

The OPGS algorithm can find only an effective motion vector near a central point (or a starting point), may incorrectly converge on a local minimum point, may not obtain the correct result in a complex image having complex motion, and requires a substantial amount of calculation to find a motion vector over a long distance.

### SUMMARY OF THE INVENTION

The present invention provides a method for motion estimation based on hybrid block matching, in which a modified full-search algorithm and a fast search algorithm are combined in a video compression system, thereby performing a fast search and enhancing compression efficiency through a search for a global minimum point.

The present invention also provides a method and apparatus for converting a frame rate using a method for motion estimation based on hybrid block matching.

According to an aspect of the present invention, there is provided a method for motion estimation based on hybrid block matching in a video compression system. The method comprises dividing a current frame into blocks and performing a full search algorithm on blocks sampled from the divided blocks, allocating a motion vector (iMV) obtained through linear interpolation to non-sampled blocks in the current frame based on motion vectors (fMV) obtained through performing the full search algorithm, and performing a fast search algorithm using the motion vector obtained through the linear interpolation as a search starting point.

According to another aspect of the present invention, there is provided an apparatus for converting a frame rate, the apparatus comprising a frame buffer, a hybrid motion estimation unit, and a motion compensated interpolation unit. The frame buffer stores an input video on a frame-by-frame basis. The hybrid motion estimation unit performs a full search algorithm on sampled blocks among blocks in a current frame that are stored in the frame buffer, allocates a motion vector obtained through linear interpolation to non-sampled blocks in the current frame based on motion vectors obtained through full search, and performs a fast search algorithm using the motion vector obtained through linear interpolation as a search starting point. The motion compensated interpolation unit generates pixel values to be interpolated between frames based on the motion vector estimated by the hybrid motion estimation unit.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a method for motion estimation based on hybrid block matching according to an exemplary embodiment of the present invention;

FIG. 2 illustrates full-search motion vector estimation for sampled blocks of FIG. 1;

FIG. 3 illustrates motion estimation using overlapping blocks of FIG. 1;

FIG. 4A illustrates a motion estimation (ME) block composed of sampled pixels of FIG. 1;

FIG. 4B illustrates a motion compensated interpolation (MCI) block;

FIG. 5 illustrates motion vector allocation to an non-sampled block using bilinear interpolation of FIG. 1;

FIG. 6 illustrates a motion vector calculated using bilinear interpolation of FIG. 1;

FIG. 7 illustrates neighboring blocks that define a search area for an arbitrary block of FIG. 1;

FIG. 8 is a conceptual diagram of a fast search algorithm that starts with the motion vector allocated to the non-sampled block of FIG. 1; and

FIG. 9 is a block diagram of an apparatus for converting a frame rate according to an exemplary embodiment of the present invention.

### DETAILED DESCRIPTION OF EXEMPLARY EMBODIMENTS OF THE INVENTION

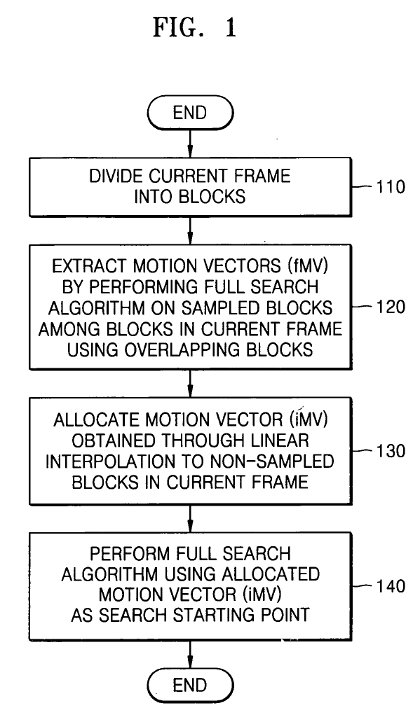

FIG. 1 is a flowchart illustrating a method for motion estimation based on hybrid block matching according to an exemplary embodiment of the present invention.

The present invention utilizes the fact that a motion vector of a block in a current frame and motion vectors of its neighboring blocks have the same or similar characteristics between two temporally neighboring frames.

In a first operation 110, a video signal that is being currently input on a frame-by-frame basis is divided into blocks. Then, specific blocks are sampled from among the divided blocks at predetermined intervals. Thus, the entire block is divided into sampled blocks that are subject to full searching and non-sampled blocks that are not subject to full searching.

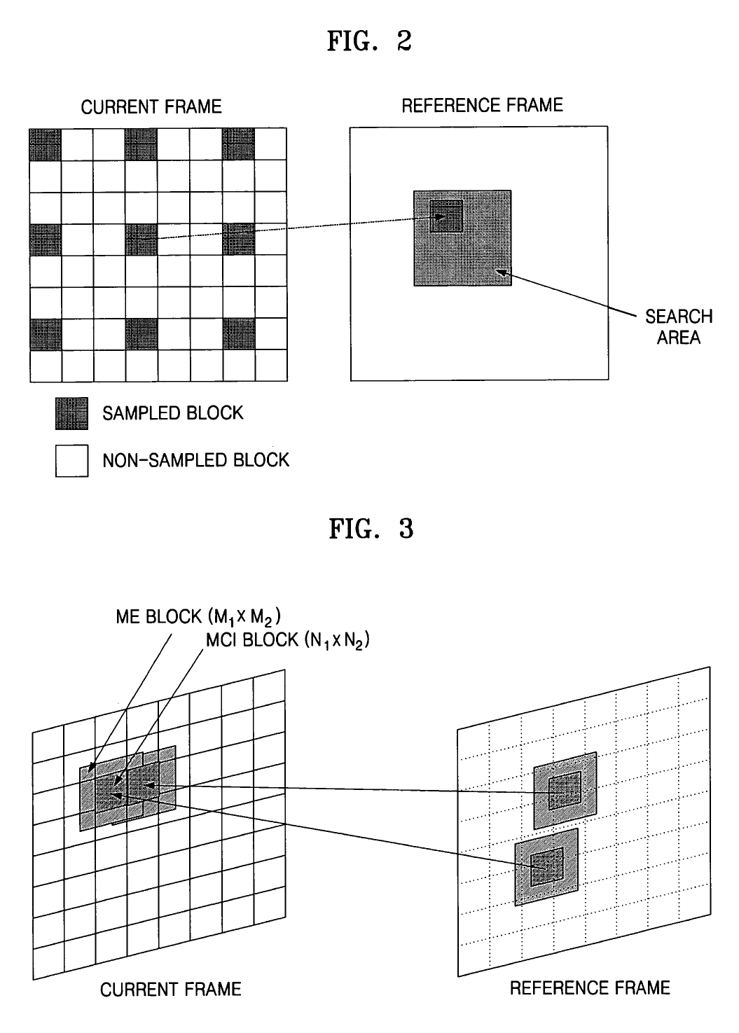

In operation 120, a full-search algorithm is performed on the sampled blocks in a current frame using overlapping blocks. Referring to FIG. 2, MADs between the sampled block in the current frame and reference blocks in a search area of a reference frame are calculated and coordinates (x,y) of a location having the minimum MAD are decided to be a motion vector.

For example, when an (n−1)^{th} frame Fₙ₋₁ and an n^{th} frame Fₙ are given, MADs between a block in a current frame (Fₙ₋₁) and reference blocks in a search area of a previous frame (Fₙ) are calculated as shown in Equations 1 and 2, and a spatial distance between a block having the minimum MAD and the block in the current frame (Fₙ₋₁) is decided as a motion vector. First, the MADs are calculated as follows:

$${MAD}_{( κ , l )} ( χ , γ ) = {\sum }_{i = 1}^{{N}_{1}} {\sum }_{j = 1}^{{N}_{2}} \frac{\vert {f}_{n - 1} ( k + i + χ , l + j + y ) - {f}_{n} ( k + i , l + j ) \vert}{{N}_{1} \times {N}_{2}}$$

where n is a variable indicating an order of input frames in a time domain, (i,j) are spatial coordinates of pixels, (x,y) indicate a distance between two matched blocks, (k,l) are spatial coordinates of two blocks composed of N₁×N₂ pixels, and N₁ and N₂ are horizontal and vertical dimensions of each of the two matched blocks.

The motion vector of the block having the minimum MAD in a motion estimation area is obtained as follows:

$${( {χ}_{m} , {γ}_{m} )}_{( k , l )} = {arg min}_{( χ , γ ) ∈ S} \{ {MAD}_{( k , l )} ( χ , γ ) \}$$

where S is a search range for motion estimation and (xₘ, yₘ) represent the motion vector of the block having the minimum MAD.

At this time, the full-search algorithm generally uses standard-compliant blocks like MPEG 1/2-compliant blocks, but may use overlapping blocks as shown in FIG. 3.

In other words, pixels in a frame are divided into motion compensated interpolation (MCI) blocks of N₁×N₂ pixels and motion estimation (ME) blocks of M₁×M₂ pixels that have the same central axis as the MCI blocks and are larger than the MCI blocks. For example, the ME block size may be 32×32 and the MCI block size may be 16×16. Also, an M₁×M₂ ME block is spaced apart from its neighboring blocks (which are located on the left side, the right side, above, and below the M₁×M₂ ME block) horizontally by N₁ and vertically by N₂. Thus, the M₁×M₂ ME block overlaps its neighboring blocks. Pixels in an ME block are sub-sampled 1:2 or less.

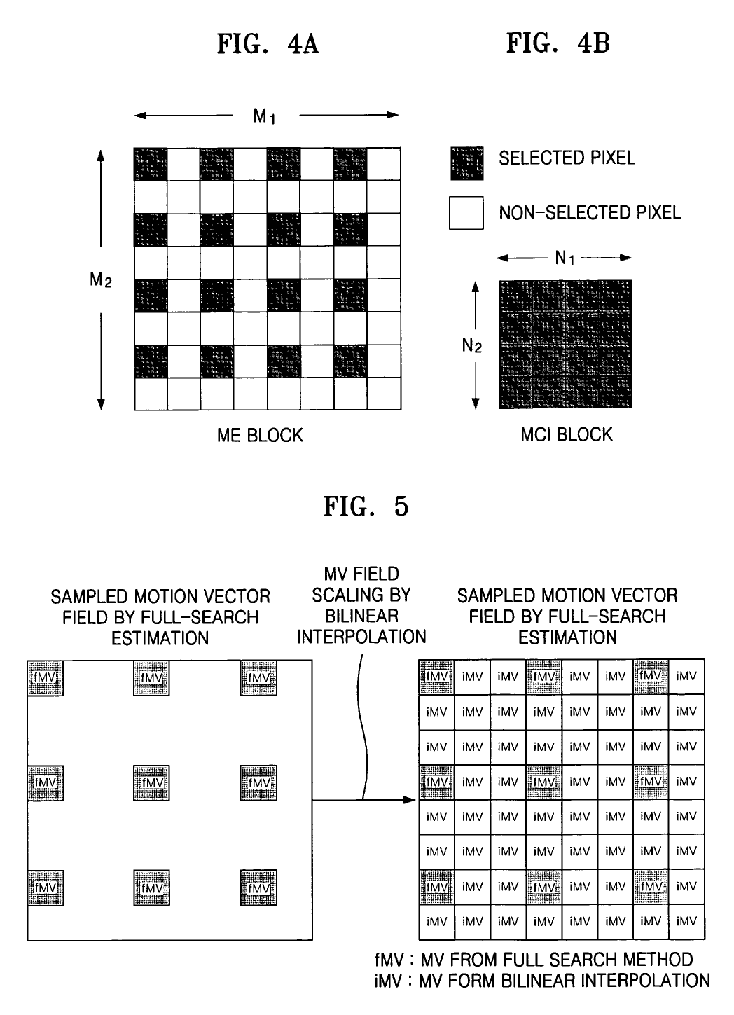

FIG. 4A illustrates an M₁×M₂ ME block in which pixels are sub-sampled 1:2 and selected pixels and non-selected pixels are divided, and FIG. 4B illustrates an N₁×N₂ MCI block. Thus, the full-search algorithm performs motion estimation on an M₁×M₂ ME block using an overlapping MCI block that is smaller than the M₁×M₂ ME block.

Thus, the MAD using the sampled ME block can be expressed as follows:

$${MAD}_{( κ , l )} ( χ , γ ) = {\sum }_{i = 1}^{[ {M}_{1} / a ]} {\sum }_{j = 1}^{[ {M}_{2} / a ]} \frac{{a}^{2} \vert {f}_{n - 1} ( k + a i + x , l + a j + y ) - {f}_{n} ( k + a i , l + a ) \vert}{{M}_{1} \times {M}_{2}}$$

where α is a sampling coefficient for sampling pixels in an ME block, [M/α] is the largest integer that is not greater than M/α, M₁×M₂ is an ME block size, and M₁ and M₂ are set greater than N₁ and N₂ of Equation 1.

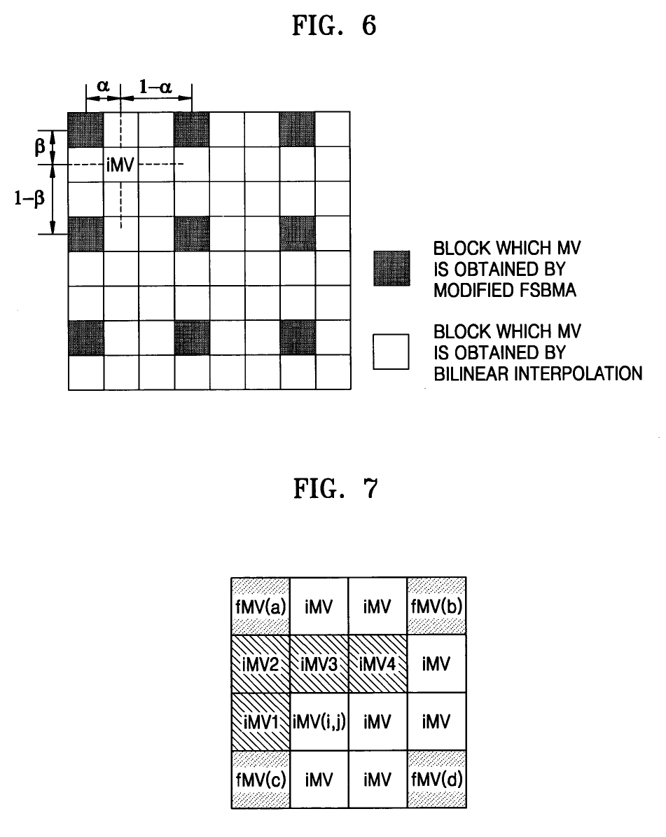

Next, in operation 130, a motion vector iMV obtained through bilinear interpolation is allocated to the non-sampled blocks in the current frame using a motion vector fMV obtained through a full search as shown in FIG. 5. Using the fact that a motion vector of a block in a current frame and motion vectors of its neighboring blocks have the same or similar characteristics between two temporally neighboring frames, bilinear interpolation for the non-sampled blocks in FIG. 6 can be expressed as follows:
iMV=(1−β)[(1−α)fMV₁+αfMV₂]+β[(1−α)fMV₃+αfMV₄] (4),
where fMV₁₋₄ indicates motion vectors of four nearest blocks, which are obtained through a full search, and α and β are horizontal and vertical rational constants between fMV and iMV.

In operation 140, a fast search algorithm is performed using the motion vector iMV obtained through bilinear interpolation as a search starting point. Also, instead of the fast search algorithm, a fine search algorithm that estimates a motion vector by performing a full search in a small range, e.g., a range of ±2 or ±4, may be used. Examples of the fast search algorithm include an HSBMA, an OPGS, a TSS algorithm, a diamond algorithm, an FSS algorithm, and a gradient search algorithm.

At this time, a search area for the fast search is variably determined with reference to motion vectors of neighboring blocks that are nearest to a corresponding block or motion vectors of neighboring blocks of the corresponding block that are obtained through a full search algorithm. In other words, as shown in FIG. 7, a search starting point for an ME block iMV(i,j) whose coordinates are (i,j) is a given initial value. Based on the given initial value, a search area (SA) is determined using motion vectors of neighboring blocks by one of the following methods:

1) SA=MAX{|fMV(a)−iMV(i,j)|, |fMV(b)−iMV(i,j)|, fMV(c)−iMV(i,j)|, |fMV(d)−iMV(i,j)|}, where fMV(a) through fMV(d) indicate motion vectors of neighboring blocks of a block iMV(i,j) that are obtained in an early stage.

2) SA=MAX{|iMV1−iMV(i,j)|, |iMV2−iMV(i,j)|, |iMV3−iMV(i,j)|, |iMV4−iMV(i,j)|}, where iMV1 through iMV4 indicate motion vectors of blocks that are located on the left side, the upper left side, above, and on the upper right side of the block iMV(i,j).

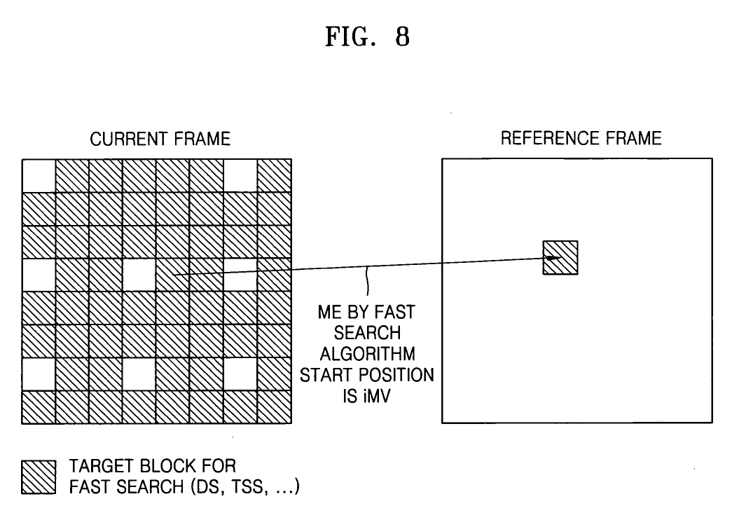

As shown in FIG. 8, a fast search algorithm is performed to determine a location at which a target block in a current block and a block in a reference frame are matched. For example, a local minimum point of a search area in the reference frame is searched using a motion vector iMV obtained through bilinear interpolation for a block in the current frame as a search starting point. Then, if the local minimum point is found, searching is stopped and a location of the local minimum point is determined as a motion vector for the block in the current frame.

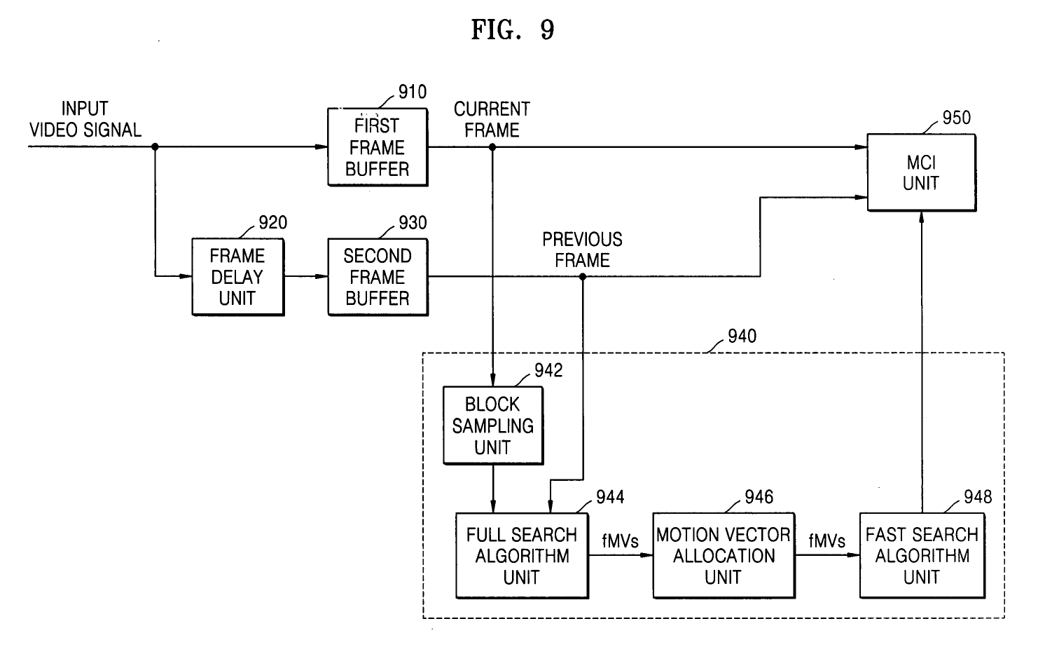

FIG. 9 is a block diagram of an apparatus for converting a frame rate using the method for motion estimation based on hybrid block matching according to an exemplary embodiment of the present invention.

The frame rate converter of FIG. 9 includes a first frame buffer 910, a frame delay unit 920, a second frame buffer 930, a hybrid motion estimation unit 940, and a motion compensated interpolation (MCI) unit 950. The hybrid motion estimation unit 940 includes a block sampling unit 942, a full-search algorithm unit 944, a motion vector allocation unit 946, and a fast search algorithm unit 948.

Referring to FIG. 5, the first frame buffer 910 stores an input video signal on a frame-by-frame basis. For example, a video signal of an n^{th} frame is stored in the first frame buffer 910. A video signal that is delayed by one frame in the frame delay unit 920 is stored in the second frame buffer 930. For example, an (n−1)^{th} frame is stored in the second frame buffer 930.

The hybrid motion estimation unit 420 extracts motion vectors of all possible blocks using a hybrid search algorithm between the n^{th} frame and the (n-1)^{th} frame. In other words, the block sampling unit 942 samples some of the blocks in the n^{th} frame. The full search algorithm unit 944 estimates motion vectors fMV by performing a full search algorithm between the sampled blocks of the n^{th} frame and blocks of the (n-1)^{th} frame. The motion vector allocation unit 946 performs bilinear interpolation based on the motion vectors fMV obtained by the full search algorithm unit 944 and allocates the motion vector iMV obtained through bilinear interpolation to the non-sampled blocks. The fast search algorithm unit 948 performs a fast search algorithm using the motion vector iMV allocated to the non-sampled blocks as a search starting point.

The MCI unit 950 performs motion compensation by applying the motion vectors fMV and iMV that are estimated by the hybrid motion estimation unit 940 to the blocks of the n^{th} frame and the (n−1)^{th} frame that are stored in the first and frame buffer 910 and the second frame buffer 930 and generates pixel values to be interpolated between the n^{th} frame and the (n−1)^{th} frame based on the estimated motion vectors fMV and iMV and pixel values of blocks that are matched between the n^{th} frame and the (n−1)^{th} frame.

As described above, according to the present invention, by combining a modified full search algorithm and a fast search algorithm, it is possible to perform a fast search and improve compression efficiency by searching for a global minimum point. In particular, by using the modified full search algorithm, the amount of initial motion estimation is reduced and the actual performance of motion estimation can be enhanced. Also, by using a modified search area in the fast search algorithm, the speed of search can be improved.

Meanwhile, the present invention can also be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for motion estimation based on hybrid block matching in a video compression system, the method comprising:
dividing a current frame into a plurality of blocks and performing a full search algorithm on sampled blocks of the plurality of blocks;
allocating a motion vector (iMV) obtained through linear interpolation to non-sampled blocks of the plurality of blocks in the current frame based on motion vectors (fMV) obtained through the performing of the full search algorithm; and
performing a fast search algorithm using the motion vector obtained through the linear interpolation as a search starting point.

2. The method of claim 1, wherein the performing of the full search algorithm comprises calculating mean absolute differences (MADs) between the sampled blocks in the current frame and reference blocks in a search area of a reference frame and determining coordinates (x,y) of a location having a minimum MAD to be a motion vector.

3. The method of claim 1, wherein in the performing of the full search algorithm, the sampled blocks in the current frame have a size of M₁×M₂ pixels and overlap with motion compensated interpolation (MCI) blocks having a size of N₁×N₂ pixels, pixels in the sampled blocks of M₁×M₂ pixels are sampled, and M₁ and M₂ are larger than N₁ and N₂.

4. The method of claim 1, wherein the motion vector obtained through the linear interpolation is expressed as follows:
iMV=(1−β)[(1−α)fMV₁+αfMV₂]+β[(1−α)fMV₃+αfMV₄]
where fMV₁₋₄ indicates motion vectors of four nearest blocks that are obtained through a full search, α and β are horizontal and vertical rational constants between the motion vector (iMV) obtained through the linear interpolation and the motion vectors (fMV) obtained through the full search.

5. The method of claim 5, wherein the search area of the fast search algorithm is variably determined with reference to motion vectors of neighboring blocks that are nearest to a corresponding block.

6. The method of claim 5, wherein the search area (SA) is given by
SA=MAX{|fMV(a)−iMV(i,j)|, |fMV(b)−iMV(i,j)|, |fMV(c)−iMV(i,j)|, |fMV(d)−iMV(i,j)|},
where (i,j) are spatial coordinates of pixels, iMV(i,j) is a motion vector obtained through the linear interpolation in a block and fMV(a) through fMV(d) are motion vectors obtained by performing the full search algorithm on neighboring blocks of the block.

7. The method of claim 5, wherein the search area (SA) is given by
SA=MAX{|iMV1−iMV(i,j)|, |iMV2−iMV(i,j)|, |iMV3−iMV(i,j)|, |iMV4−iMV(i,j)|},
where (i,j) are spatial coordinates of pixels, and iMV1 through iMV4 are motion vectors of neighboring blocks of a block.

8. The method of claim 1, wherein the performing of the fast search algorithm comprises searching for a local minimum point in a search area of a reference frame using the motion vector obtained through the linear interpolation on a block in the current frame as the search starting point, stopping the search if the local minimum point is found, and deciding the local minimum point as a motion vector of the block in the current frame.

9. A method for converting a frame rate, the method comprising:
dividing a current frame into a plurality of blocks and performing a full search algorithm on sampled blocks of the plurality of blocks;
allocating motion vectors (fMV) obtained through linear interpolation to non-sampled blocks of the plurality of blocks in the current frame based on a motion vector (iMV) obtained through the performing of the full search algorithm;
performing a fast search algorithm using the motion vector (iMV) obtained through the linear interpolation as a search starting point; and
generating pixel values to be interpolated between an n^{th} frame and an (n−1)^{th} frame based on motion vectors that are estimated through the fast search algorithm and pixel values of blocks that are matched between the n^{th} frame and the (n−1)^{th} frame.

10. An apparatus for converting a frame rate, the apparatus comprising:
a frame buffer which stores an input video on a frame-by-frame basis;
a hybrid motion estimation unit which performs a full search algorithm on sampled blocks of a plurality of blocks in a current frame that are stored in the frame buffer, allocates a motion vector obtained through linear interpolation to non-sampled blocks of the plurality of blocks in the current frame based on motion vectors obtained through the full search algorithm, and performing a fast search algorithm using the motion vectors obtained through the linear interpolation as a search starting point; and
a motion compensated interpolation unit which generates pixel values to be interpolated between frames based on motion vectors estimated by the hybrid motion estimation unit.

11. The apparatus of claim 10, wherein the hybrid motion estimation unit comprises:
a block sampling unit which samples some of the blocks in the current frame;
a full search algorithm unit which estimates motion vectors by performing the full search algorithm between the sampled blocks of the current frame that are sampled by the block sampling unit and blocks in a previous frame;
a motion allocating unit which allocates the motion vector obtained through the linear interpolation to the non-sampled blocks based on the motion vectors obtained by the full search algorithm unit; and
a fast search algorithm unit which performs the fast search algorithm using the motion vectors allocated to the non-sampled blocks as the search starting point.
